(19) United States
(12) Patent Application Publication
(10) Pub. No.: US 2004/0030992 A1
(43) Pub. Date: Feb. 12, 2004

(54) System and method for management of a virtual enterprise

(76) Inventors: Trandafir Moisa, Bucharest (RO); Jason M. Fisher, Collierville, TN (US)

Correspondence Address: BUTLER, SNOW, O'MARA, STEVENS & CANNADA PLLC, 6075 POPLAR AVENUE, SUITE 500, MEMPHIS, TN, 38119, US

(21) Appl. No.: 10/213,307

(22) Filed: Aug. 6, 2002

(51) Int. Cl. G06F 17/00

(52) U.S. Cl. 715/513

(57) ABSTRACT

A system and method for management of a virtual enterprise is disclosed. The present invention is a computer program product that provides web-based integration of five major management processes. These processes include: community/user management, project management, document and workflow management, communications management and quality assurance management.

### RELATED APPLICATIONS

N/A

### REFERENCE TO APPENDIX”

The computer program listing appendix submitted on a compact disk is hereby incorporated by reference. Two duplicate copies of a single disk are included. The disk was created on May 28, 2002 and contains the files as appended.

### FIELD OF THE INVENTION

The present invention relates to a system for management of a virtual enterprise and, more specifically, to a method and tool to manage a variety of virtual enterprise activities.

### BACKGROUND OF THE INVENTION

Virtual Enterprise Management System (VEMS) is a unique computer program product, as it brings together project management, community/user management, communication management, document workflow management, and quality management in a collaborative environment providing also user management as a highly integrated and scalable web based application.

Other computer program implementing management system products offer basic level management functions. For example, SAP® Business Services provides the sustained optimization of business processes in complex SAP® environments, starting with internal and statutory auditing to production planning and materials management, through to sales and marketing, human resources and e-business.

Under the name PeopleSoft® Enterprise Resource Planning, this software product is made of complementary personnel and financial management modules, plus a complete range of integration services. Human resource management covers all personnel-specific processes and enables efficient processing and delivery of the information a basic level management need. The financial management system is a solution for company-wide, international and consolidated financial management.

The virtual enterprise management system provides high level management needs required by the advanced hierarchical management systems, especially for decision support in the higher levels of the management hierarchy, complementing the basic level management needs assured by the SAP® and Peoplesoft®. High level management is based on evaluation and estimation reports and comparison with actual values provided by the basic level management applications. High level management provides prediction to the executive level of decision like the estimation of the project or task finish time or cost.

### SUMMARY OF THE INVENTION

The present invention provides a web based integrated collaborative system to implement certain management processes and subprocesses. These processes include: community management, project management, document and workflow management, communications management and quality assurance management. This system, by integrating these key management functions, provides greater efficiency than nonintegrated systems. This greater efficiency results in easy of use and higher user productivity.

More specifically, virtual enterprise management system provides, on top of the basic level management for prior systems, the following features: 1) communication management, for a better conveyance of decisions and notifications, together with a sophisticated agenda or adviser implemented as a ‘ToDo’ list; 2) project management, with advanced reporting based on evaluation and estimation methods required by the high level management; 3) community management, to deal with a hierarchically structured user communities based on user roles in the project and in the organization; 4) document and workflow management implemented as a flexible document repository with archive and version control, together with workflows like ‘document preview and approval’; 5) quality management, that integrates the standards and documents of the global recognized quality standards of ISO 9000 (Products & Services), ISO 14000 (Environment), ISO 18000 (OHSMS Employee) and CMM (Software Development) in the document repository as predefined templates that can be used either for certification or as a management tool for the quality assurance activities management.

A computer program product is disclosed. The computer program product is a computer usable medium having computer readable program code means therein for facilitating the web based management of a virtual enterprise. The computer readable program codes mean in the computer program product is a computer readable program code means facilitating the web based management of a virtual enterprise by system process integration of defined management processes. The defined management processes are: community management; communication management; project management; document and workflow management; and quality assurance management.

A program storage device readable by a machine tangibly embodying a program of instructions executable by the machine to perform method steps for facilitating the management of a virtual enterprise by users via the web is provided. The method steps involve facilitating the management of communities; facilitating the management of activities organized in projects; facilitating the management of documents; facilitating the management of communications; facilitating the management of quality assurance; and integrating steps (a) through (f).

A system for allowing pre-designated users at remotely located computer-based systems to perform management of a virtual enterprise is provided. The system involves a data network; a remote storage facility; and at least four servers to deploy a computer program for causing a computer to facilitate management of a virtual enterprise by integrating defined management processes.

### BRIEF DESCRIPTION OF THE DRAWINGS:

FIG. 1 is a block diagram of the virtual enterprise management system providing the components and the interaction between them.

FIG. 2 is a block diagram of the community management process of the virtual enterprise management system.

FIG. 3 is a block diagram of the project management process of the virtual enterprise management system.

FIG. 4 is a block diagram of the communication management process of the virtual enterprise management system.

FIG. 5 is a block diagram of the document and work flow management process of the virtual enterprise management system.

FIG. 6 is a block diagram of the quality assurance management process of the virtual enterprise management system.

FIG. 7 is a block diagram of the project reports section of the project management process of the virtual enterprise management system.

FIG. 8 is a diagram of the process for the entire system life cycle.

FIG. 9 is a data flow diagram which depicts the flow of data in the document and work flow management process of the virtual enterprise management system.

FIG. 10 is a data flow diagram which depicts the flow of data in the document preview and approval subprocess of the virtual enterprise management system.

FIG. 11 is a data flow diagram which depicts the flow of data in the change request management process of the virtual enterprise management system.

FIG. 12 is a data flow diagram which depicts the deployment architecture of the virtual enterprise management system.

FIG. 13 is a schematic of multi tier VEMS architecture.

FIG. 14 is a data flow diagram which depicts the flow of data in the project management process of the virtual enterprise management system.

FIG. 15 is a data flow diagram which depicts the flow of data in the task management process of the virtual enterprise management system.

FIG. 16 is a data flow diagram which depicts the flow of data in project budget management process of the virtual enterprise management system.

FIG. 17 is a GANTT chart provided by the project reports section of the project management process of the virtual enterprise management system.

FIG. 18 is a report showing critical paths for a selected project provided by the project reports section of the project management process of the virtual enterprise management system.

FIG. 19 is a report of resource cost for a selected project provided by the project reports section of the project management process of the virtual enterprise management system.

FIG. 20 is a report of project status provided by the project reports section of the project management process of the virtual enterprise management system.

FIG. 21 is a view of projects brief information provided by the project management process of the virtual enterprise management system.

### DETAILED DESCRIPTION OF THE INVENTION

In the following description, for purposes of explanation, numerous specific details are set forth in order to provide a thorough understanding of the present invention. It will be evident, however, to one skilled in the art that the present invention may be practiced without these specific details. In other instances, well-known structures and devices are shown in block diagram form in order to facilitate description. All patents referenced are incorporated by reference.

ACWP is total actual costs incurred (direct and indirect) in accomplishing work during a given time period. ACWP is used in the earned value method of progress measurement. Actual cost incurred (spent) on work to date can be expressed as a percentage i.e. Actual percent Expenditure=ACWP×100/BCAC.

Access Control controls the ability to enter the site of the project works and/or the necessary project data.

Application Server is a three-tier client/server environment that provides middle tier processing between the user's machine and the database management system (DBMS).

Baseline is a value of a parameter stored for further comparison with a scheduled or actual value.

BCAC is the cost anticipated at the start of a project representing the sum total of budgets time-phased in accordance with the baseline schedule. When summed at selected higher-level elements of the Work Breakdown Structure, this should include both direct and indirect budgets.

BCWP is a measure used in cost control that allows you to quantify the overall progress of the project in monetary terms. BCWP is calculated by applying a performance measurement factor to the planned cost. BCWP=percentage completion×BCAC (baseline cost), i.e. it equals the percentage complete multiplied by the planned cost for each task at the current time. Another term for BCWP is Earned Value or Achieved Cost.

BCWS is Cost that is budgeted (according to the baseline plan) up to current date and is calculated by: (Current Date−Baseline Start Date)×Baseline Cost/Baseline Duration. BCWS equals the planned percentage complete multiplied by the planned cost for each task at the current time, which itself is based upon the planned date and the current date.

| | |
|---|---|
| CAN | Contract Acceptance Notification. |
| CCR | Contract Change Request. |
| CM | Change Management. |

CMM (Capability Maturity Model for Software) is a model for judging the maturity of the software processes of an organization and for identifying the key practices that are required to increase the maturity of these processes. The CMM has been developed by the software community with stewardship by Software Engineering Institute.

| | |
|---|---|
| CP | Company Presentation. |
| CR | Customer Requirements. |
| CRN | Contract Request Notification. |

Computer—The present invention is not limited as to the type of computer on which it runs. The computer typically includes a keyboard, a display device such as a monitor, and a pointing device such as a mouse. The computer also typically comprises a random access memory (RAM), a read only memory (ROM), a central processing unit (CPU), and a storage device such as a hard disk drive or a floppy disk drive.

CV (Cost Variance)=BCWP−ACWP.

Data Network is a collection of data processing devices interconnected by a communication infrastructure and governed by communication protocols including both public and private data networks.

DBMS (Database Management System) Software that controls the organization, storage, retrieval, security and integrity of data in a database. It accepts request from the application and instructs the operations systems to transfer the appropriate data.

DCWM—Document-Centric Workflow Management.

Document Control is a system for controlling and executing project documentation in a uniform and orderly fashion.

Document Management is the orderly and appropriate organization, distribution, storage and retrieval of project documents.

Document repository deals with documents, which are any official or authoritative paper containing instructions, information, evidence, facts and the like.

| | |
|---|---|
| DP | FS + PBS/WBS + TAC. |
| DPAN | Development Plan Acceptance Notification. |
| DPCR | Development Plan Change Request. |
| DPRN | Development Plan Request Notification. |

Executive Information Center—Everything a user with executive rights can see in VEMS as an integration of the five main processes 3, 43, 13, 17, 73.

FS—Functional Specifications.

High Level Design provides a general description of the software system including its functionality and matters related to the overall system and its design (including a discussion of the basic design approach or organization).

HTML (Hypertext Markup Language). A standard coding convention and set of codes for attaching presentation and linking attributes to informational content within documents. (HTML 2.0 is currently the primary standard used for generating Web documents.) During a document authoring stage, the HTML codes (referred to as “tags”) are embedded within the informational content of the document. When the Web document (or HTML document) is subsequently transferred from a Web server to a browser, the codes are interpreted by the browser and used to parse and display the document. Additionally in specifying how the Web browser is to display the document, HTML tags can be used to create links to other Web documents (commonly referred to as “hyperlinks”). For more information on HTML, see Ian S. Graham, The HTML Source Book, John Wiley and Sons, Inc., 1995 (ISBN 0471-11894-4, hereby incorporated by reference).

HTTP (HyperText Transfer Protocol). The standard World Wide Web client-server protocol used for the exchange of information (such as HTML documents, and client requests for such documents) between a browser and a Web server. HTTP includes a number of different types of messages which can be sent from the client to the server to request different types of server actions. For example, a “GET” message, which has the format GET <URL>, causes the server to return the document or file located at the specified URL.

Internet—A collection of interconnected (public and/or private) networks that are linked together by a set of standard protocols (such as TCP/IP and HTTP) to form a global, distributed network. (While this term is intended to refer to what is now commonly known as the Internet, it is also intended to encompass variations which may be made in the future, including changes and additions to existing standard protocols.)

ITC—Integration Test Cases.

Lifecycle—The course of developmental changes through which a system progresses through as series of differing stages of development.

Low Level Design—Most components described in the High-Level Design document will require a more detailed discussion. Other lower-level components and subcomponents may need to be described as well. In the introduction describe the kind of component, such as a subsystem, module, class, package, function, file, etc. and the specific purpose and semantic meaning of the component.

ISBN (International Standard Book Number). A numerical identifier associated with books, pamphlets, educational kits, microforms, CD-ROM and Braille publications in circulation throughout the world. The ISBN is a ten-digit number assigned to each published title that provides an unduplicated, internationally recognized “identity.” The ISBN number can be a product code.

OCR (Optical character recognition) is the process of converting an image of text, such as a scanned paper document or electronic fax file, into computer-editable text. The text in an image is not editable: the letters are made of tiny dots (pixels) that together form a picture of text. During OCR, the software analyzes an image and converts the pictures of the characters to editable text based on the patterns of the pixels in the image. After OCR, you can export the converted text and use it with a variety of word-processing, page layout and spreadsheet applications.

| | |
|---|---|
| OFCR | Offer Change Request. |
| OAF | Offer Analysis Form. |
| OAN | Offer Acceptance Notification. |
| ORN | Offer Refusal Notification. |

PBS/WBS (Project Breakdown Structure/Work Breakdown Structure)—A list with a specific format that records all the work products (deliverables) and the work elements (phases, tasks, subtasks, etc) with the time and cost estimation, resource allocation and scheduling for each one. Project—A novel undertaking or systematic process to create a new product or service the delivery of which signals completion. Projects involve risk and are typically constrained by limited resources. It is also a process for conducting work that produces a new product of one sort or another. Every project defines the organizational framework to develop a system. The system is the durable we obtain when a project is completed. The project defines, plans and monitors the actions to develop a system in all steps involved in the system life cycle. TEM provides the environment and the tools to test and accept the system developed in the frame of a project, during the system life cycle.

Project evaluation is the process in which the project manager and the team make an assessment of the project goals. If they are totally met or not, or there are special aspects that has to be taken into account during the next projects, like scheduling errors, underestimating resources proficiency or other technical aspects.

Project Report—is a report showing current status to senior personnel, sponsors or stakeholders summarizing the progress of a project including key events, milestone, costs and other issues.

RDBMS is a relational DBMS.

Relational Database is a database organization method that links files together as required.

SAT—System Acceptance Test Cases.

SCALABLE ARCHITECTURE—Architecture designed so that might be improved or extended easily with new processes or sub processes.

System Architecture—The project defines plans and monitors the actions to develop a system in all steps involved in the system life cycle. TEM is dealing with the resulting project artifacts we called systems in the virtual enterprise management system. TEM provides the environment and the tools to test and accept the system developed in the frame of a project during the system life cycle.

System Process Integration—The process of bringing people, activities and other things together to perform effectively; a way of terminating a project by bringing team members back into the organization and distributing project results and outcomes among existing functions; the bringing of people and things together to perform effectively; the successive combining and testing of system hardware assemblies, software components, and operator tasks to progressively prove the performance and compatibility of all components of the system; and the software development activity in which separate software components are combined into an executable whole.

SPI (Schedule Performance Index)=BCWP/BCWS.

System Lifecycle Workflow is the workflow for a system lifecycle. A system is the resulting object of a project.

System tuning is the process of adjusting the system parameters in order to achieve the maximum performance allowed by the implementation.

System optimization is the process of identification and possible redesigning of parts of the system in order to obtain better performances.

TEM—Test & Error Management.

Threshold Management is the management of the difference between an actual value of a parameter (like BCWS in Earned Value Analysis for example), and the range setup in 138 or the baseline setup in 908. A baseline is a value of a parameter stored for further comparison with a scheduled or actual value to allow the executive or project manager to see if a project parameter is in between organization ranges or that the schedule has been changed during the project lifecycle.

URL (Uniform Resource Locator) is a unique address which fully specifies the location of a file or other resource on the Internet. The general format of a URL is protocol://machine address: port/path/filename. The port specification is optional, and if none is entered by the user, the browser defaults to the standard port for whatever service is specified as the protocol.

User—A community participant that can include, for example, geographically dispersed internal team members, customers, suppliers, consultants/contractors, or any other party involved in managing one or more business relationships.

UTC—Unit Test Cases.

Version control—Controlling the variants of some artifacts; later versions of an artifact typically expand on earlier versions.

Virtual Enterprise—Networked confederation of physical locations, business units, business partners and subcontractors governed by harmonized business processes across the enterprise.

Virtual Hierarchical Structured Community Work Places—The work groups formed by human resources structured in communities in a hierarchical manner according to their project role. The responsibilities and access rights are allocated according to the hierarchy of each person in the community.

Web Server—A computer that provides world wide web services on the Internet.

Web Site—is a computer system that serves informational content over a network using the standard protocols of the World Wide Web. Typically, a Web site corresponds to a particular Internet domain name. As used herein, the term is generally intended to encompass both (i) the hardware/software server components that serve the informational content over the network, and (ii) the “back end” hardware/software components, including any nonstandard or specialized components, that interact with the server components to perform services for Web site users.

Work Flow is the relationship of the activities in a project from start to finish. Work flow takes into consideration all types of activity relationships.

Workflow Engine is a workflow engine controls the execution of defined processes and sub processes. Based on this graphical description of the workflow, the workflow engine automatically creates, keeps track and monitors tasks and their related actions and documents.

Workflow Management System—A system that completely defines, manages, manages workflow through the execution of software whose order of execution is driven by a computer representation of the workflow logic. It involves modeling as well as a run time companion.

World Wide Web (“Web”)—Used herein to refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

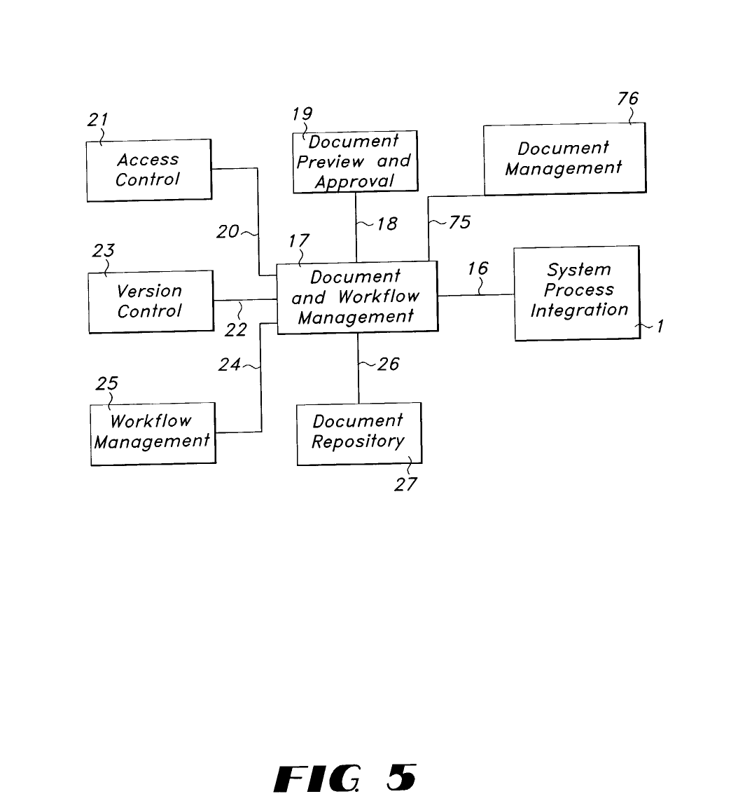

Virtual Enterprise Management System (VEMS) is a computer program product that facilitates collaborative business management and provides an Internet workspace that allows a user to communicate, share, manage and distribute information associated with projects and their tasks related to virtual enterprise activities. VEMS is a web based system that provides collaboration between users. VEMS facilitates collaboration between users by integrating five business processes. VEMS provides a workflow engine to execute projects from start to finish. A user can use a graphical toolkit accessible via a web browser (as shown in FIGS. 5, 8 and 9) to direct this workflow engine. Based on this graphical description of the workflow, the workflow engine automatically creates, keeps track and monitors tasks and their related actions and documents. The automated workflow engine can work totally independent, the only user intervention being for performing the actions required by task description or for monitoring the other user activities. Besides this automatic behavior of the engine, if desired, the user can manually control it, by adding new tasks, change assignments and forcing task completion, for example.

The present invention relates to a computer program product. The computer program product is a computer usable medium having computer readable program code means to facilitate the management of a virtual enterprise. The computer readable program code means for causing a computer to facilitate management of a virtual enterprise by the system process integration of defined management process. The present computer program product provides a means to group, organize, export, import and manage customers and suppliers more effectively.

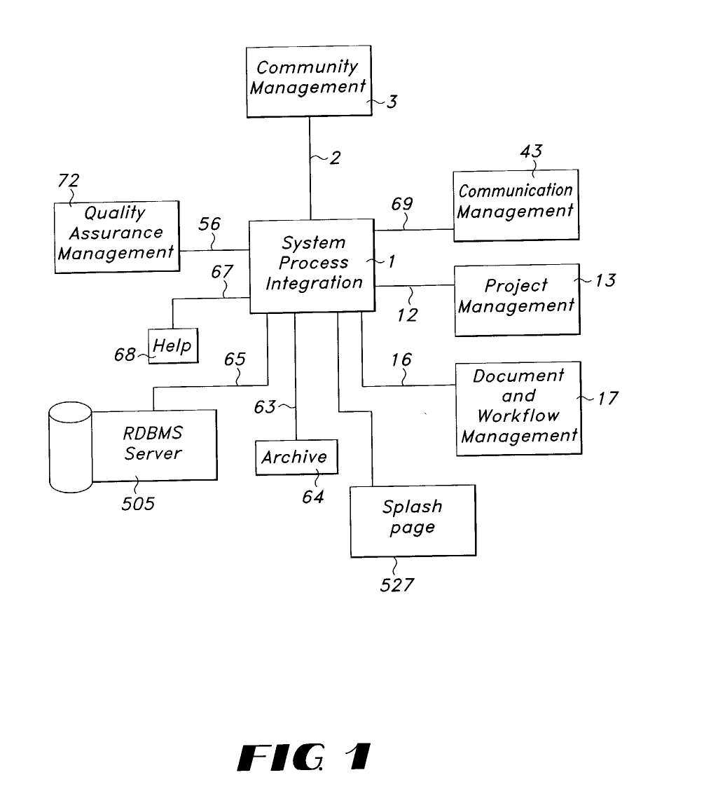

FIG. 1 depicts a block diagram in which system process integration 1 of five defined management processes: community management 3, document and work flow management 17, project management 13, communications management 43, and quality assurance management 72 processes is shown. The system process integration 1 means communicates via a communication pathway 2 with the community management 3 process via a communication pathway 2, such as a software bus. System process integration means 1 communicates via communication pathway 69 with communication management 43 process. The system process integration means 1 communicates via the communication pathway 12 with project management 13 process. The system process integration means 1 communicates via communication pathway 16 with document and work flow management process 17. The system process integration means 1 communicates with the quality assurance management 72 process via communications pathway 56. System process integration is the process of bringing together these processes to perform effectively as shown in FIG. 1. All of these processes and subprocesses are set out in computer readable program code in the computer program listing appendix.

More specifically, in FIG. 5, the workflow management 25 subprocess acts as a document dispatcher between document repository 27 and document preview and approval 19 via communication pathways 24, 18, 26. The workflow management 25 subprocess acts as a PBS/WBS (Project Breakdown Structure/Work Breakdown Structure) manager via communication pathways 24, 16, 12, and 32 for the task management 34 subprocess. The workflow management 25 subprocess functions as a workflow engine. It also provides means for task allocation for the change management 42, test and error management 38, and document preview and approval 19 subprocesses via communication paths 24, 18, 16, 12, 32, 37 and 41.

The system process integration 1 means communicates via communication path 63 with archive 64. Archive process 64 stores the information about closed projects for future use. The system process integration 1 means communicates via a communication pathway 65 with relational database 505. The function of the relational database 505 is to store data. Examples of relational databases include Oracle® (Redwood Shores, Calif.) and LDAP (Netscape, Mountain View, Calif.). The processes are computer readable program code means for causing a computer to: facilitate management of activities organized in projects; facilitate management of documents; facilitate management of communications and to facilitate management of quality assurance.

A. Community Management

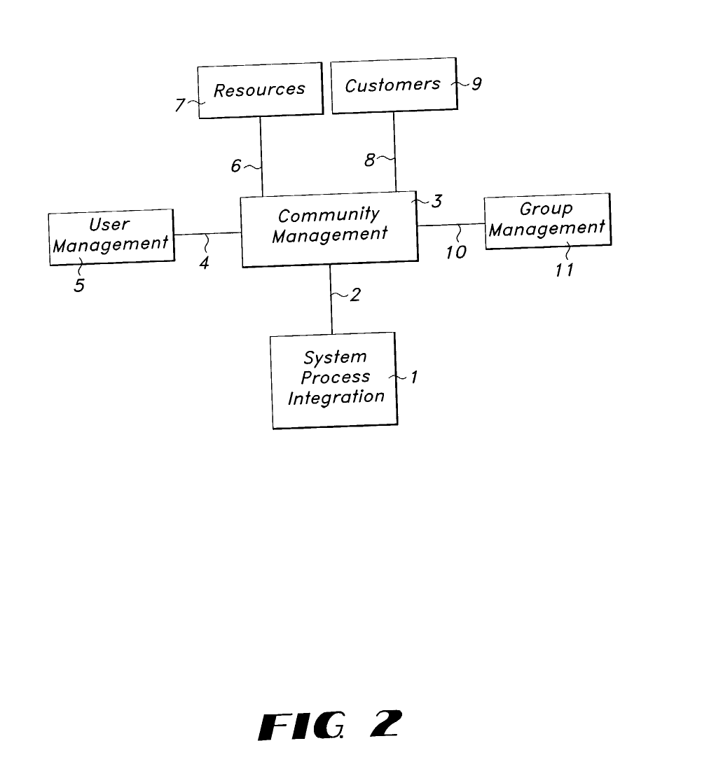

Referring now to FIG. 2, a community management 3 process is shown. The community management 3 process provides management of activities that are performed by people grouped into communities on a distributed work environment. Distributed work environment is a geographically dispersed environment offered by a virtual enterprise. The community management 3 process also provides management of communities in a hierarchal manner according to their project or organizational role. The community management 3 process communicates via a communication pathway 10 with group management 11. Group management 11 defines the process of creating, deleting and editing groups of communities. Group management is mainly used to manage the complexity of a virtual enterprise with a large number of projects grouped in communities which are part of a group.

The community management 3 process communicates via a communication pathway 8 to customers 9. Customers 9 are the beneficiaries of the systems developed in the frame of a project. The community management 3 process communicates via a communication pathway 6 with resources 7. Resources 7 mean specialists who are able to execute different tasks in the project. The community management 3 process communicates via a communication pathway 4 with user management 5. User management 5 defines the process of creating, deleting and editing VEMS users, grouping them in communities and managing access rights based on project role of each user, for each project where the user is a resource.

The projects in the system can be organized in communities (FIG. 2). Every community has associated with it a set of projects and users. The setup of each community is done by a special user titled “Community Administrator”. A community administrator can use system process integration 1 to build a virtual hierarchical structured community work place. Virtual hierarchical structured community work places are the work groups formed by human resources structured in communities in a hierarchical manner according to their project role. The responsibilities and access rights are allocated according to the hierarchy of each person in the community. A community administrator can add users, edit user information, set up payment rates per individual user according to skills and experience on a project basis and in different currencies. The community administrator controls user access and subprocesses a user has access to. The users that do not belong to a community cannot enter in it, i.e. they have no access to its projects or data. If a user is a member of two or more communities, the name of the community is displayed on each page so that the user knows the community he is currently in. The user has the ability to change the community he is currently in by clicking the ‘change community’ button. A list of communities the user has access to is displayed so he can selected the community he needs to access in.

Adding a new community requires the community administrator to fill in fields like Community Name, Group, Template, in group management 11 and save it in project reports 31, which is a repository of project reports used to present the information to the users in a readable format, on the screen or printer. Adding a new user action requires filling in the required information: Login, First Name, Last Name, Password, Confirm Password, Phone, E-mail, Company Name, Skills, Certifications and not only, the fields that are marked within the form with. After filling in all the required fields, you can save the new user. The CV (curriculum vitae or resume) file can be uploaded so that a project manager or a client can refer later on in order to choose the right resources for a specific task or project. The CV might be replaced with any other reference information that is suitable for certain types of business, for example, hospitals, where adding a new user means adding a new patient and the CV for that patient might be the monitoring file. All user information can be listed with their full names, roles, communities, and last login times.

The added communities are displayed grouped in a tree like structure, where leafs are the community names. Clicking on a specific group expands that group and the user can see the communities that belong to that specific group. When the user clicks on a community, its details are shown and the user can edit details or delete that specific community. Clicking on a specific group expands that group and the user can see the communities that belong to that specific group. When the user clicks on a community, its details are shown and the user can edit details or delete that specific community. By mean of user management 5 subprocess the project manager has the ability to specify the project user's rights to access the virtual enterprise management processes.

B. Project Management 13 Process

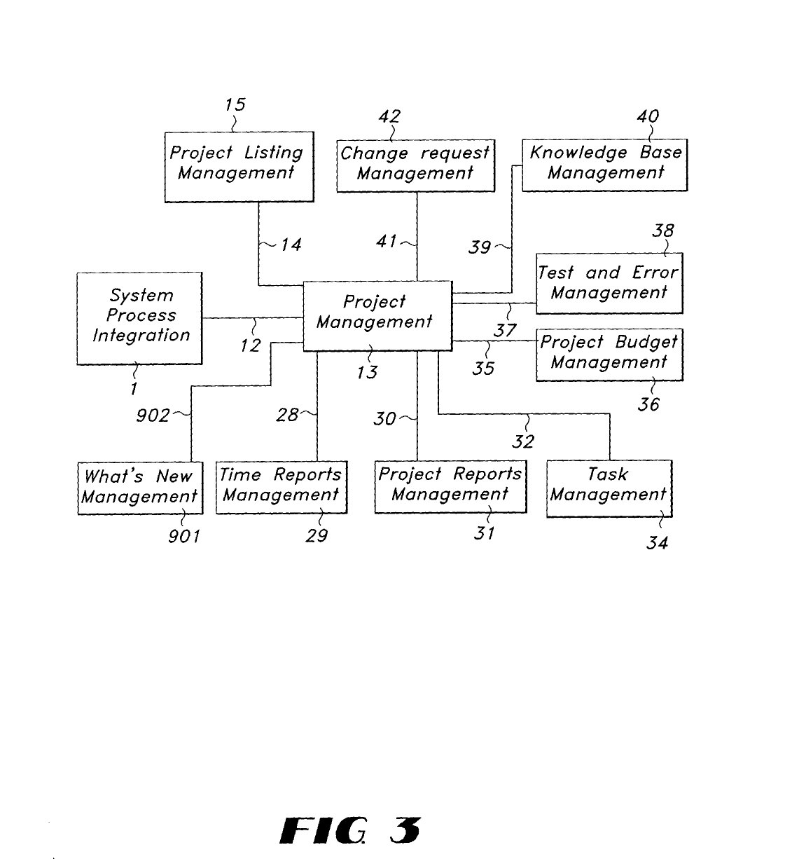

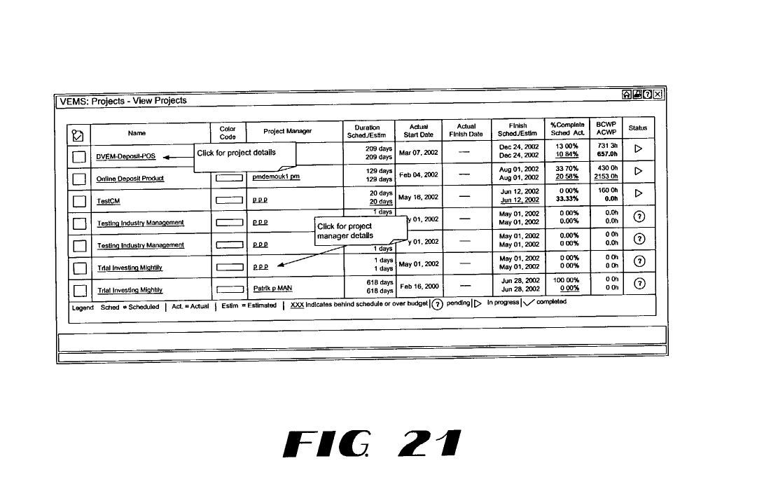

Now referring to FIG. 3, project management process 13 is shown. Project management 13 process provides management of activities organized into projects. Project management 13 refers to process of planning, monitoring and control of all aspects of a project and the motivation of all those involved in it to achieve the project objectives on time and to specified cost, quality and performance. The projects management 13 process provides a means for planning activities by editing the start/finish date, resource allocation, displaying the activity status, and notifying the project manager of status changes. The users that have at least project manager rights may access a list of all projects (active and archived) within the current community by clicking on the link from the top menu. This section also contains information related with tasks within projects. The project listing (See FIG. 21) displays high level project information (project name, project manager, duration scheduled/estimated, actual start date, actual finish date, finish estimated/scheduled, percent of completion scheduled/actual, BCWP/ACWP status (on/ahead schedule, in progress, behind schedule, in progress, completed behind schedule, waiting, on/ahead schedule, waiting). Color codes can be used for dates, budget and percent of completion to denote on or behind schedule.

By contrast with two dimension time management systems which provide the user with the ‘scheduled’ time for as one dimension and the ‘actual’ time as the other dimension, VEMS provides the third time management dimension which is the ‘estimated’ time for a project or project task. The estimation of project completion date is done by the system, based on the percentage of completion of all tasks and the time reports entered by the users allocated to tasks, which differentiate VEMS from the two dimension time management systems. Based on the estimated finish time high level management reports are delivered based on the projection of the projects behavior in the future. The first two dimensions are covered by the basic level management systems. VEMS covers especially the third dimension which is one of the key features of the high level management systems in order to provide prediction to the executive management. This way the executives can prevent issues instead and detecting and solving them.

1. Project Listing Management 15 Subprocess

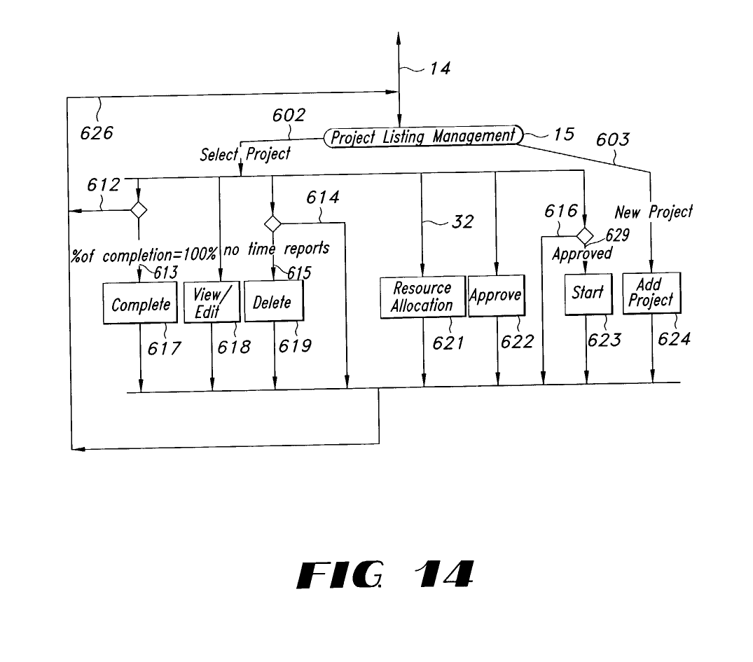

The project management 13 process communicates via communication path 14 with project listing management 15 subprocess. The project listing management 15 process is detailed in FIG. 14. The user may add a new project 624 via communication pathway 603. The project details might be viewed or edited 618, deleted 619 (only if no time reports have been posted), approved 622, started 623 (only if the project is approved) or completed 617 via communication pathways 602. Communication pathways 614, 616 are used when the conditions ‘approved’, ‘no time reports are posted’ are not met. Project tasks are managed by task management 34 via communication pathway 32. A project might be archived 64 after completion 617 via communication path 63, 12.

2. Change Request Management 42 Subprocess

The project management 13 process communicates via communication path 41 with the change request management 42 subprocess. The change request management 42 subprocess is an enhanced project management tool designed to give better control of project related ‘changes’. By ‘change’ we understand a general term for any ‘request’ from another project user like a client or stakeholder to ‘modify’ a project resulting artifact or process. Documented in the change request is information on the origin and impact of the current problem, the proposed solution, and its cost.

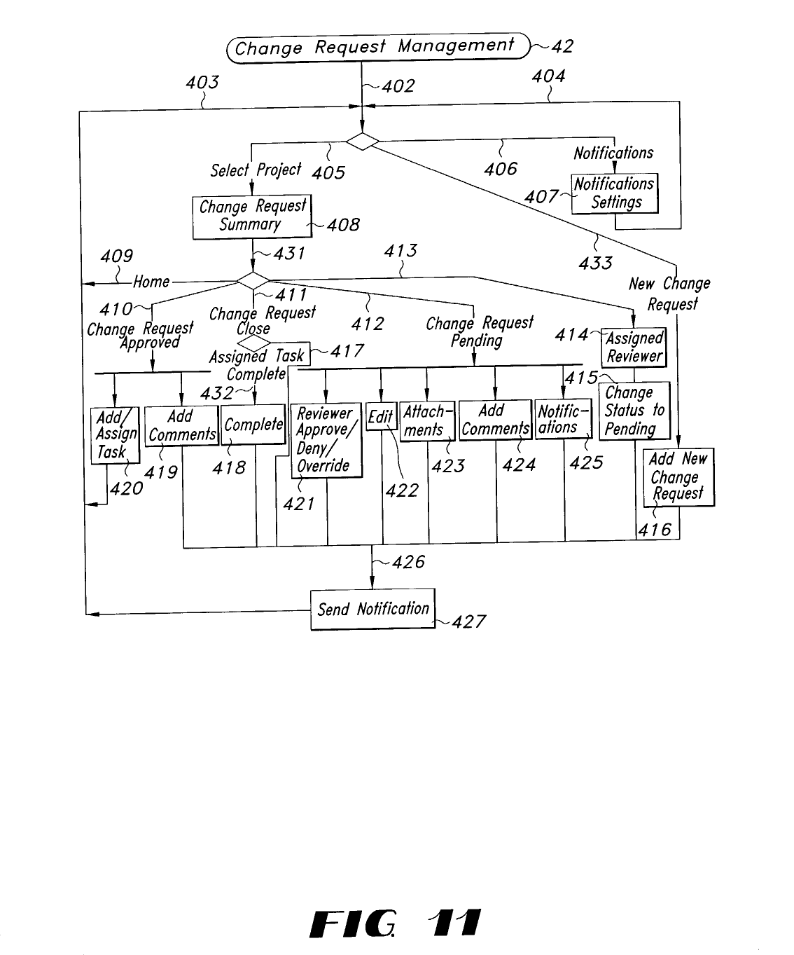

The change management 42 subprocess provides means to manage project changes to give the user better control of project related ‘changes’. It allows the user to initiate and record all ‘change’ request, to assign responsibilities and to track the change through its lifecycle. It also allows seeing the impact of the changes in time, cost, and quality for any given project. The change request management 42 subprocess is detailed in FIG. 11.

A new change request is added 416 via communication pathway 433. The user may select a project via communication pathway 405. Notifications 427 are sent to the assigned reviewer 414 whenever 419, 418, 421, 422, 423, 424, 415, 416 are performed by the project manager. A request is needed to obtain formal approval/deny/override 421 for changes to the scope, design, methods, costs or planned aspects of a project via communication pathway 412. Change request may arise through changes in the business or issues in the project. Change requests should be logged 416 assessed 421 and executed 420. Requests arise through changes in the business or issues in the project. Change requests should be logged, assessed, and approved on before a change to the project can be made. Changes may affect the scope, quality, time and/or cost of the project. The user may add comments 424 or attachments via 423. The responsible persons for a change are notified through communication management 43 and notifications section 45 via communication pathway 44.

3. Knowledge Base Management 40 Subprocess

The project management 13 process communicates via communication path 39 with knowledge base management 40 subprocess. Knowledge is the fact or condition of knowing something with familiarity gained through experience or association. For example, the sum of what is known such as the tools and techniques of effective project management. Knowledge base is the sum of knowledge that is basic to the given circumstances, e.g. the organization's estimating database, or anecdotal records of risk events on past projects, etc. Knowledge management is the acquisition, management, and distribution of relevant information to the parties who need to know.

4. Test and Error Management 38 Subprocess

The project management 13 process communicates via communication path 37 with test and error management 38 subprocess (TEM). The test and error management 38 subprocess provides means to manage errors and issues occurred during the testing activities, allowing for development of the test cases and test suites during design time, posting of errors during testing time and error solving during debugging time. The testing documentation includes system/acceptance test cases, integration test cases, and unit test cases. These documents are produced at design time and they are grouped in test suites during the testing iterations. Once a test suit is generated, the project manager needs to schedule a task and the test suites are handed over to the testers. Once a test case in a test suite has failed, the whole test suite has failed and a test error document in automatically produced. Once an error document is generated, the project manager assigns a task for solving the error. Resources allocated to a test task or to a debug task might be automatically notified by email. The project manager may allow certain access rights to each of the project resources to the test and error documents, and means for sharing of test and error documents of almost any type. Instead of sending attachments via email, the user can instantly upload a test or error document to the VEMS system and have a team member at the airport or at a satellite office open and view or, if necessary, download the document.

The Test & Error Management 38 process allows a user and team to share test and error documents of most any type. Instead of sending attachments via email, you can instantly upload a test or error document to the present system and have a team member at the airport or at a satellite office open and view or, if necessary, download the document. The system testing documentation is made of the system/acceptance test cases SAT, integration test cases ITC, unit test cases UTC. These documents are produced at design time, contains testing instructions needed by the tester during testing activity and they are grouped in test suites during the testing iterations. Once a test suite is generated, the project manager needs to schedule a task and the test suites are handed over to the testers

Every project defines the organizational framework to develop a system. The system is the durable we obtain when a project is completed. The project defines plans and monitors the actions to develop a system in all steps involved in the system life cycle. TEM is dealing with the resulting project artifacts we called systems in the virtual enterprise management system. TEM provides the environment and the tools to test and accept the system developed in the frame of a project during the system life cycle.

The project manager needs to configure the system architecture by adding the systems and system versions to the project. Viewing the same architecture at a more detailed level, a given system (or sub-system) may be implemented by several distinct processes (or sub-process), which may be individually identified as components (or sub-components). The system testing documentation is made of the system/acceptance test cases SAT, integration test cases ITC, unit test cases UTC. These documents are produced at design time, contains testing instructions needed by the tester during testing activity and they are grouped in test suites during the testing iterations. Once a test suite is generated, the project manager needs to schedule a task and the test suites are handed over to the testers. Once a test case in a test suite has failed, the whole test suite has failed and a test error document is automatically produced. Once an error document is generated, the project manager assigns a task for solving the error. Resources allocated to a test task or to an error solving task might be automatically notified by email. The project manager may allow certain access rights to each of the project resources to the test and error documents.

TABLE 1
Rules for destination options

| | | | | | Test | Test |
|---|---|---|---|---|---|---|
| | System | Process | Component | Test Case | Suite | Error |
| Project | ✓ | — | — | — | — | — |
| System | ✓ | ✓ | — | ✓ | ✓ | ✓ |
| Process | — | ✓ | ✓ | ✓ | ✓ | ✓ |
| Component | — | — | ✓ | ✓ | ✓ | ✓ |
| Test Case | — | — | — | — | — | — |
| Test Suite | — | — | — | ✓ | — | ✓ |
| Test Error | — | — | — | — | — | — |

5. Project Budget Management 36 Subprocess

The project management 13 process communicates via communication pathway 35 with project budget management 36 subprocess. The project budget management 36 subprocess allows a user with project manager rights to edit a list of accounts of two categories ‘expense’ and ‘income’ via communication pathway 903 called also settings. The user may schedule the project ‘income’ and ‘expense’ all over the project life cycle so that he can schedule the cash flow before the project start and monitor the project budget after the project start by comparing the scheduled costs (expense, income) with actual costs registered by means of accounting documents like checks or transfers.

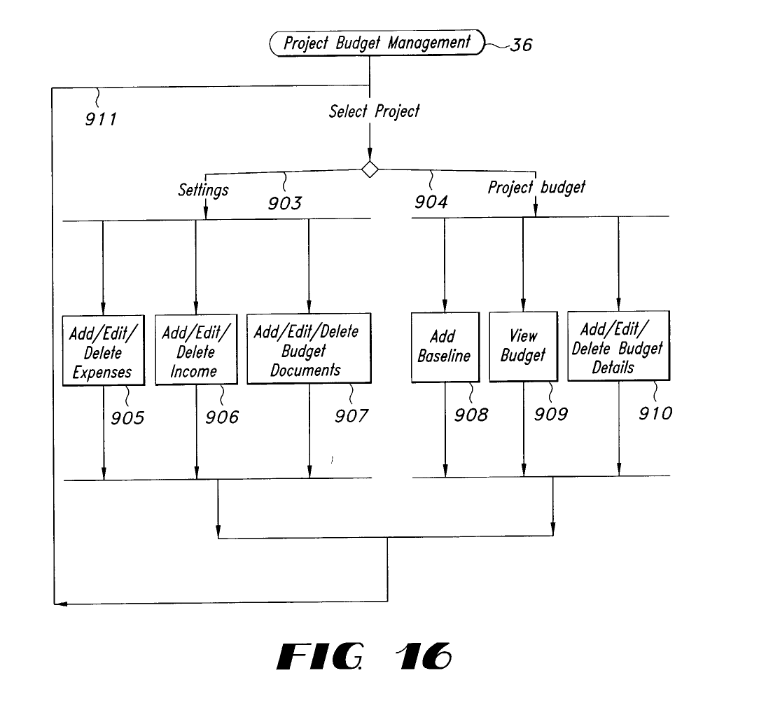

More specifically, with respect to FIG. 16, project budget management 36 subprocess communicates via communication pathway 35 and 903 with add/edit/delete expenses 905 function, add/edit/deleted income 906 function, add/edit/delete budget documents 907. Project budget 36 communicates via communication pathway 35 and 904 called project budget with add baseline 908, view budget 909 and add, edit, delete budget details 910.

6. Task Management 34 Subprocess

The project management 13 process communicates via communication pathway 32 with task management 34 subprocess. The Task management 34 subprocess provides means for grouping activities into tasks and summary tasks for managing the task list complexity by means of collapsing/expanding detailed tasks into/from summary tasks.

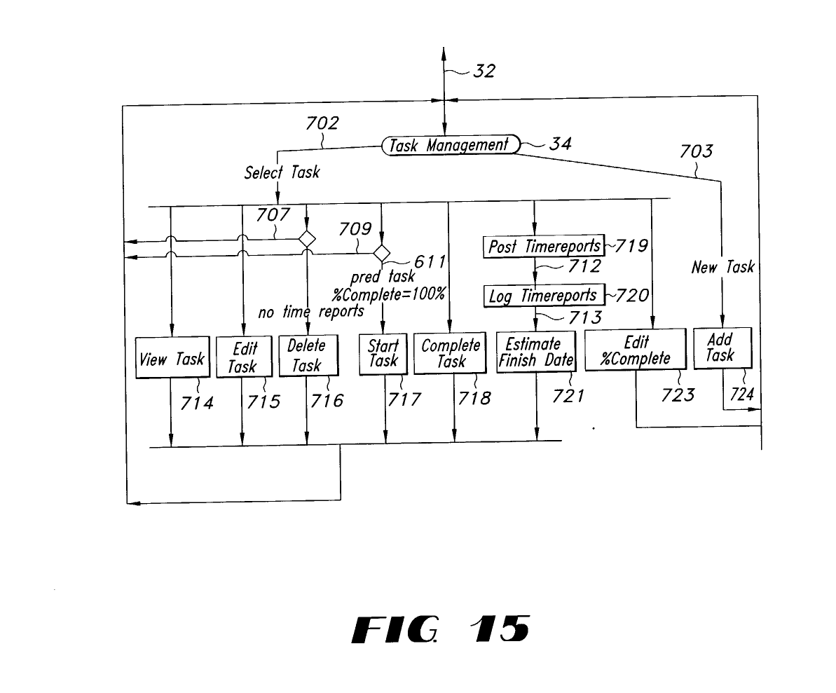

The task management subprocess 34 is detailed in FIG. 15. The user may add a new task 724 via communication pathway 703 and then edit, delete (only if no time reports are posted) tasks 715, 716. The task details might be viewed or edited 714 started 717 (only if the predecessor task is 100% completed) or completed 718 via communication pathways 702. The user may post time reports 719, the time reports are logged by the system 720 and edit percentage of completion 723 via communication pathways 702, 712, 713. Also an estimated finish time 721 is provided to the user via communication pathway 32.

7. Project Reports Management 31 Subprocess

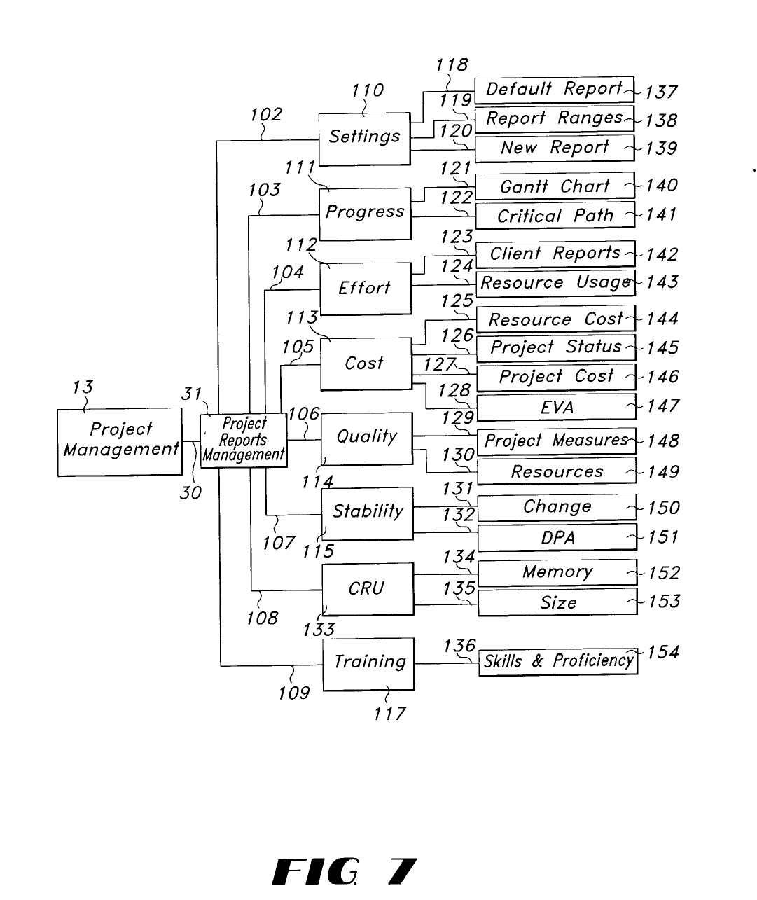

The project management 13 process communicates via communication pathway 30 with project reports management 31 subprocess. Project reports management 31 is a planning activity involved with the development and issuance of (internal) time management analysis reports and (external) progress reports. The project reports management 31 subprocess provides a means for delivering project reports like progress, effort, cost, stability, quality, computer resource utilization and training. More specifically with reference to FIG. 7, project report communicates via communication pathway 102 with Settings 110 process. In Settings 110 process the user may choose the report that is displayed by default when a user enters the reports 32 subprocess. Setting 110 communicates via 118 with default report 137, via 119 with report ranges 138 and via 120 with new report 139. The project management 13 process communicates via communication pathway 31 with project reports 31. Project reports 31 communicate via communication pathway 103 with progress 111. Progress 111 is a group of reports that allows the user to monitor the project progress. Progress 111 communicates via communication pathway 121 with Gantt chart 140 and via pathway 122 with critical path 141.

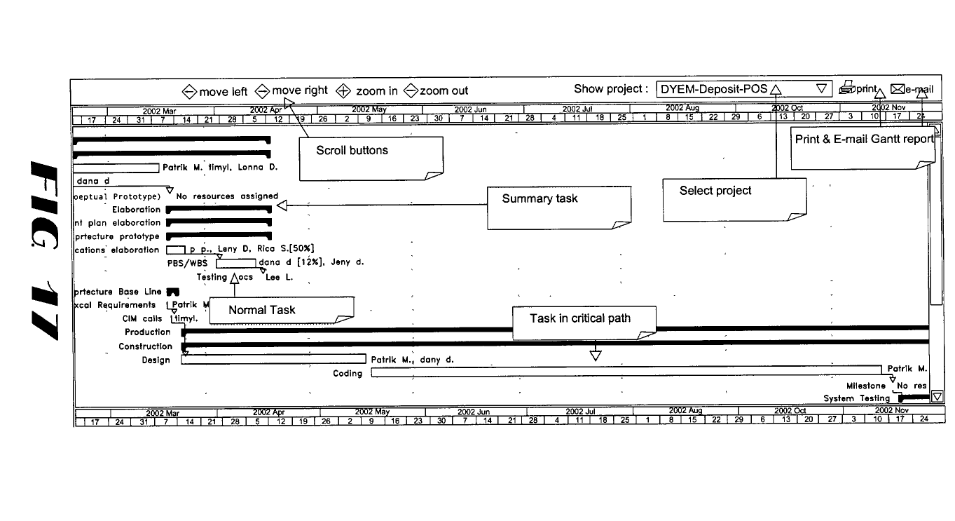

Gantt chart is a graphic display of activity durations, which are shown in the form of horizontal bars (FIG. 17). The bar's position on the timeline, and its length, indicates when that task begins and ends. In addition, the position of one task bar in relation to another indicates whether the tasks follow one after the other or if they overlap. The arrows connecting the bars represent the precedence and succession relations between tasks as shown in FIG. 17. Task dependencies (precedence/success) are represented with an arrow between the related tasks.

Critical path 141 is the series of tasks (or even a single task) that dictates the calculated finish date of the project. That is, when the last task in the critical path is completed, the project is completed. If it's important for a user's project to finish on schedule, than the user must pay close attention to the tasks on the critical path and the resources assigned to them. These elements determine whether your project will finish on time. The series of tasks are generally interrelated by task dependencies. Although there are likely to be many such networks of tasks throughout a user's project plan, the network finishing the latest is the project's critical path. Note that the critical path can change from one series of tasks to another as you progress through the schedule. The critical path can change as critical tasks are completed or tasks in another series of tasks are delayed. There is always one overall critical path for any project schedule. The new critical path then becomes the series of tasks you track more closely to ensure the desired finish date.

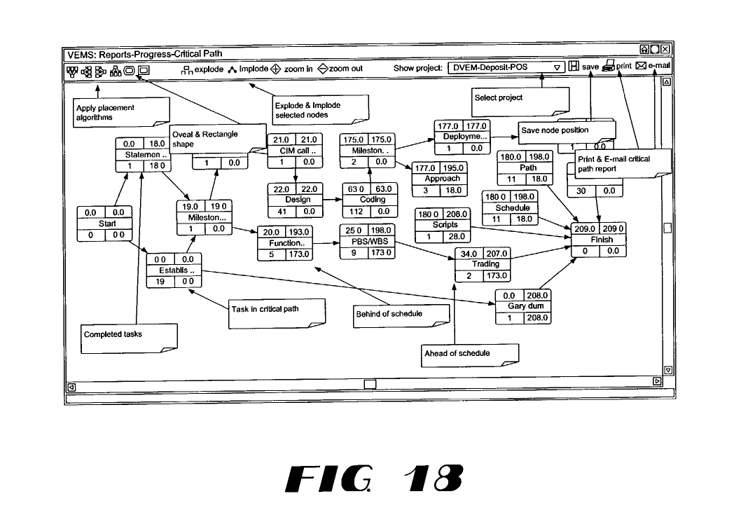

Those tasks that cannot be delayed without affecting the project finish date are the critical tasks. In a typical project, many tasks have some float and can therefore be delayed a little without affecting the project finish date. Float is the amount of time a task can be delayed without delaying other tasks or affecting the project finish date. As you modify tasks to resolve over allocations, adjust costs, or revise scope, be aware of the critical tasks and that changes to them will affect project finish date. Critical tasks make up the schedule's critical path as shown in FIG. 18.

The effort 112 process communicates via communication pathway 104 with project reports subprocess 31. Effort 112 process covers the reporting needs relative to work hours and resource usage for a specific project in a community. Effort 112 communicated via communication pathway 123 with client reports 142 section. The client report 142 section holds three reports related to resource's costs in hours: project summary; weekly report, and daily report.

The project summary report builds reports related to all resources assigned to projects in current community as a total hours posted by a user for entire outlined month. The weekly report does the same work as previous section, but all users are listed with a weekly detailed posting history. The daily report builds reports related to all resources assigned to projects in current community as a detailed report for each user against all tasks that user has been working on in the outlined week.

Effort 112 is in communication via communication pathway 124 with resource usage 143. Resource Usage 143 section holds features related to resources usage distribution in current community/project. All resources are listed as their group's name (job title) against a percent (distribution percent) and a number of each type of resources in current community/project.

The project reports 31 subprocess communicates via communication pathway 105 with cost 113 process. Cost 113 process shows the different view of the cost related to a project in a community. Cost 113 process communicates via communication pathway 125 with resource cost 144, via communications pathway 126 with project status 145 section via communication pathway 128 with project costs 146, and via communication pathway 128 with earned value analysis 147 section.

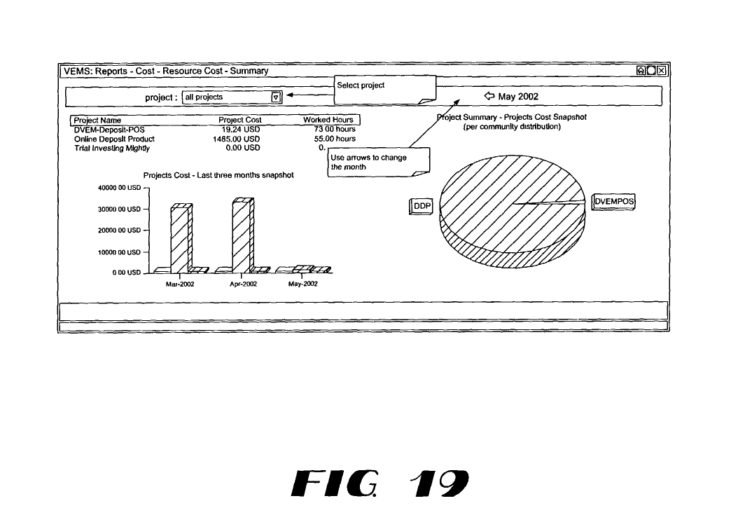

Resource Cost 144 section (builds reports related to money) a resource has to be paid according with worked hours and invoice settings. Invoice settings hold the cost settings per resource type and charge type (hourly/daily/monthly). By clicking on ‘Resources Cost’ the resource cost per community distribution report is displayed. This report, as shown in FIG. 19, contains in the left side a table displaying all projects and associated cost to them, a four month history related to last four months till current outlined one. Similarly, with reference to FIG. 19, on the right side of the report, a pie chart displays all projects that have a cost associated with it and the slice area shows the corresponding percent in current community. By holding the mouse pointer to a bar in bar chart report, a dwell label is made visible and it contains total worked hours and total cost. By double-clicking the mouse on a bar/slice from bar chart/ pie chart or selecting a project from project selector you can view the cost details for outlined project in the specified month.

A user can step forward/backward in time using arrows buttons in the top of the frame in order to view projects' cost for the specified period of time. In the project details cost page all resources assigned to current project against associated cost are displayed, a bar chart holding the history for the last four months and a pie chart where an user is represented by a slice are also displayed. By holding the mouse pointer on a slice a user can view the cost for worked hours per user.

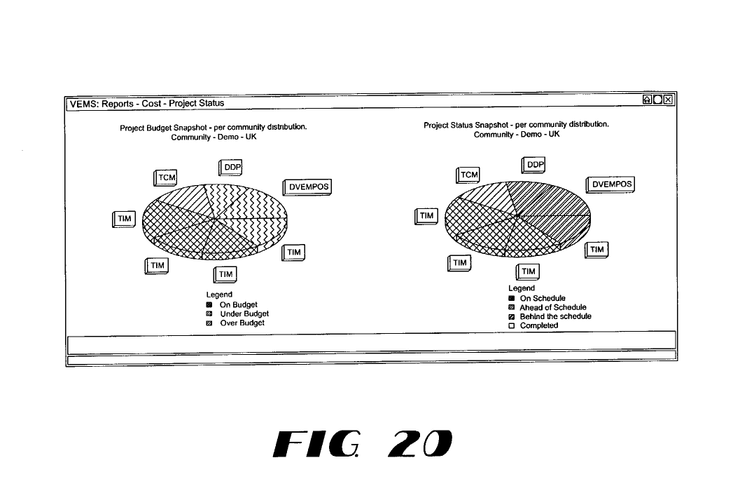

Project Status 145 section hosts reports related to project status (on schedule, behind of schedule, ahead of schedule, completed) and budget status (on budget, over budget, under budget) for all projects in current community. This report is the default page displayed in the Project Reports 138 section. With reference to FIG. 20, the left side of the frame contains a pie chart with all available projects and their budget's status. By holding the mouse pointer on a project in the budget snapshot a user can view the scheduled budget and the work completed in terms of hours. By double-clicking the mouse on a slice in budget snapshot, a detailed budget report is displayed. This detailed report contains all summary tasks from outlined project. The budget is considered in terms of hours worked/scheduled. Detailed budget reports outline worked hours against scheduled hours for each summary task. This helps the user to find out which is the problem's root in their project, if there is one. The right side of the frame contains a pie chart with all available projects in current community and theirs status in terms of completion status. It takes time to get visible: If the charts are downloaded from an Internet host, it may take few minutes to be displayed while the code is downloaded to the client machine. A label “Report loading . . . Please wait.” is displayed instead of applets until code is completely downloaded to client machine.

Project Cost 146 section hosts reports related with costs that the employer has to pay for accomplished work. The default section is Project Summary which holds information about all projects in current community. In the left side of the frame a table containing all entire costs for each project in the current community is displayed. Under this table a bar-chart with four last months history for current community is displayed. In the right side of the frame a pie-chart representing the same information as costs table is shown in order to help user identify the most expensive project in the community or the cost percentage from entire cost, for each project. Use the left/right arrows to view another month in the past/future. Click on a slice or select a project from the top available list. The “Project Cost—details section” will open. The information is presented in the same layout, as in the previous section. Summary cost table is replaced by a detailed cost table with each resource assigned to the project against its cost. The history of the selected project and its resources appears in the bottom-left. The pie chart represents each resource and its cost as a percentage of expenses for the current project.

Earned Value Analysis 147 section hosts reports related to project evolution/history in a commutative fashion. That means this chart displays at a certain moment of time the evolution of the outlined task or the evolution of the entire project. Earned value is an objective measurement of how much work has been accomplished on a project. Earned value, performance measurement, management by objectives and cost schedule control systems are synonymous terms. The use of either manufacturing standards or a line-of-balance methodology for measuring accomplishment on the factory floor is an earned value process. Earned value improves on the “normally used” spend plan concept (budget versus actual incurred cost) by requiring the work in process to be quantified. Using the earned value process, members of management can quickly compare how much work has actually been completed against the amount of work planned to be accomplished. Earned value requires the project manager to plan, budget and schedule the authorized work scope in a time-phased plan. The time phased plan is the incremental “planned value” culminating into a performance measurement baseline. As work is accomplished, it is “earned” using the same selected budget term. Earned value compared with planned value provides a work accomplished against plan. A variance to the plan is noted as a schedule or cost deviation. Normally the established accounting system provides accumulation of actual cost for the project. The actual cost is compared with the earned value to indicate an over or under run condition. Planned value, earned value, and actual cost data provides an objective measurement of performance, enabling trend analysis and evaluation of cost estimate at completion within multiple levels of the project. Project management should be applied to every project where the owners of the final product wish to ensure that the expended resources were used efficiently. On major projects, the application of good project management tools will aid in the selection of the right course when managers need to make financial and time allocation decisions.

The project reports 31 subprocess communicates via communication pathway 106 with quality 114 process. Quality 114 process is dealing with quality assurance related reports. Quality 114 process communicates via communication pathway 129 with project measures 148 section and via 130 with resources 149.

Project Measures 148 report presents a summary report that shows the total development effort in time measures, split by cost centers, like total development time for project changes, total development time for testing and error solving.

The project reports 31 subprocess communicates via communication pathway 107 with stability 115 process. Stability 115 process communicates via communication pathway 131 with changes 150 section and via 132 with DPA 151 section.

Change Report 150 provides a list with the following information for every project: for example, Pending for Approval, Approved, Denied, Completed and Approved, Completed and Denied, Estimated Cost, Scheduled Cost (BCWS), Actual Cost (ACWP).

DPA (Document Preview and Approval) report 151 provides a list with the following information for every project: Pending for Approval, Approved, Denied, Completed and Approved, Completed and Denied, Estimated Cost, Scheduled Cost (BCWS), and Actual Cost (ACWP). This report shows the document preview and approval 19 information vie pathway 132.

The project reports 31 subprocess communicates via communication pathway 108 with computer resource utilization 133 process. The computer resource utilization 133 process communicates via pathway 134 with memory 152 section and via 135 with size 153 section.

Memory Report 152 section provides a list with the following information for every project and system architecture described in Test and Error subprocess 38 via communication pathway 134 item: project name, architecture item, baseline memory, and actual memory.

Size Report 153 provides a list with the following information for every project and system architecture item: project name, architecture item, baseline size, and actual size.

Training 117 process provides information regarding resource training. Training 117 communicates via communication pathway 136 with skills and proficiency 154.

Skills & Proficiency 154 report provides the following information for each project: project name, project assigned resources, rating, skill, experience, certifications, last training date, total training duration, overall proficiency rating, and role.

8. What's New 901 Management Subprocess

The present system provides a ‘what's new’ management subprocess 901 which communicates via communication pathway 901 with project management process 13. ‘What's new’ subprocess 901 is overview information related with projects within the current community. Four distinct areas are currently available within this view together with the handling buttons: The first section displays a list of events that occur over the next 1-30 days, depending on the settings made in the customize section. As for events that System are displaying within this area: we have all the milestones the user is involved in and some default announcements. Also there is provided status information, by allocating a suggestive icon for each event, if its status is an announcements, milestones, to do, meeting one.

The second section is a summary of all the new items for the user found within different sections/process of the system claimed in (1) (i.e. new changes, new documents, new messages) The number of the new items for each is shown in a color such as red.

The third section is a short summary about the project that the user has assignments to. Displayed here is information about start date and finish-estimated date for each project, and budget and scheduling information. All the information in ‘red’ shows that there is an over-budget or over-schedule for that project, while the ‘green’ information means that the project is under budget and/or ahead of schedule. Also there is provided status information by allocating a suggestive icon for each project if its status is: in progress, pending, completed or approved. For easy access to more detailed project information the project name is linked to the project detail page.

The fourth section is a list with all the tasks the user is assigned to. For each task there is listed information that shows the tasks status in terms of schedule. Also for easy task identification, the first column contains information about the project the task belongs to and task's WBS number. There is provided status information by allocating a suggestive icon for each project if its status is on/ahead schedule, in progress, behind schedule, in progress, completed behind schedule, waiting, on/ahead schedule, waiting one. Like in the first section, the user has access to all the other detailed information about the task by following the link under the name of the task. Other colors show task in critical path. All the four areas described above may be handled by minimizing each of them using link or choosing not to be displayed if you click the minimizing icon over the link. However, the events section will always be displayed after the first time the “What's New” page is accessed within a session, no matter if the user has chosen previously that this section should be hidden or not.

9. Time Reports Management 29 Subprocess

The project management 13 process communicates via communication pathway 28 with project management 29 subprocess. Time reports are means for recording the actual effort expended against project and nonproject activities. Time reports are a record of time spent by an individual or group on a project activity. This section is related to all the time reports posted by the user that have been logged into the present invention. The main listing presents all the tasks to which the user is assigned within the current community projects and a weekly calendar for them. The user may navigate through the year in order to post/edit time reports for desired tasks.

In the list, the tasks are displayed ordered by WBS under the projects to which they belong. Only the startable or the already started tasks are presented in the list (a task is startable if all its predecessors have started and all the tasks for which it is the successor have finished). The completed tasks are present only if there are hours posted for them in the current week.

For each day and for each task, the user may introduce two types of hours, billable and non-billable, according to the user's activity during that day. Although a percentage of completion is displayed for each task, only the leader of that task will have access to update this value.

The user has access to the project details view report following the link over the projects name. A shortcut to each task details page is provided by clicking over the task name's link. One or more time reports may be created by filling-up the text fields for the corresponding days and then pressing “apply” button. This will refresh the page with the values that have just been introduced. Also, if the field for the percent of completion is editable, the value that will be introduced/modified will be updated for the task, if the value of the percent is valid and it is between 0-100. If the user chooses to edit one or more of the already created time reports, he has to select the task or tasks that have been posted as time reports against it (by selecting the corresponding checkboxes), and then pressing the “Edit” button. A note/comment for that task time report can be introduced (for example, a description of those days activity). These comments along with the sum of the posted hours can be viewed in the task details page.

The edit time reports view is very much the same as the create view, but only the reports already posted are available in order to be modified. No new time reports are allowed to be created within this view. The editing refers to the number of hours introduced, and, if the user is also the leader of that task, the percentage of completion for the task can also be introduced/edited. After the changes to the displayed fields have been made (in the related text-boxes), in order to submit them, the user has to click over the apply link. The pages will be refreshed with the newly introduced or updated values for the time reports. As it has been mentioned above, a task time reports' note/comment can be posted, for example explaining why the editing action was necessary.

C. Communication Management 43 Process

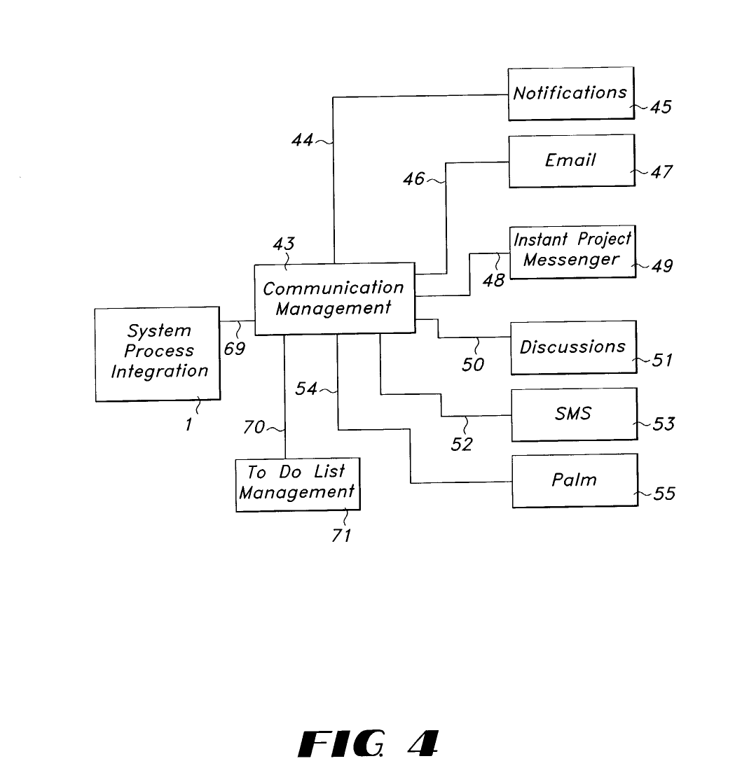

Now referring to FIG. 4, a block diagram of the communication management 43 process is shown. The communication management 43 process provides: communication management between different actors assigned to perform activities and projects grouped in communities involving: means to enhance communication and collaboration that are critical in every activity. The main features that differentiate it from other Instant Messaging Systems are users' visibility only in the community where they are belonging to and the “To Do” list that gather in a comprehensive list all the daily activities information. Users are grouped according to group and community management principles implemented in VEMS so a user can send a message to an entire community or to a team allocated to a project. This facilitates the communication by allowing message handling between users working on common projects and the “To Do” list that gather in a comprehensive list all the daily activities information.

The communication management 43 process communicates via communication path 44 with Notifications 45 subprocess. The communication management 43 process communicates via communication pathway 46 with E-Mail 47 subprocess. The communication management 43 process communicates via communication pathway 46 with instant project manager 49 subprocess. The communication management 43 process communicates via communication pathway 46 with discussions 51 subprocess. The communication management 43 process communicates via communication pathway 46 with SMS (Short Message Service) 53 subprocess. The communication management 43 process communicates via communication pathway 46 with palm 53 subprocess. The communication management 43 process communicates via communication pathway 46 with To Do List 71 subprocess.

1. Discussions 51 Management Subprocess

The discussion (FIG. 4-51) subprocess is a general or project-based bulletin board, a virtual meeting place, allowing team members to discuss ideas, ask questions, get answers, resolve issues, providing an efficient communication, independent of geographic location. The discussion 41 subprocess includes: 1) discussions: these are high level subjects that contain discussion topics. In the main display area when first logging on a user will see the listing of all discussions available to a user. A user will also see the number of topics that are in that discussion, the last date a message was posted and the name of the person who created the discussion; 2) Topics: topics are focus areas within a main discussion to help organize the communication within a community or project. A discussion can have many topics. In the main display area when first at the topics for a discussion, a user will see the listing of all topics available. A user will also see the number of messages the topics, the last date a message was posted and the name of the person who created the topic; and 3) Messages: Referred also as Postings. Each topic will have messages or postings from any number of users. There is no limit to the number of messages for any selected topic. The messages posted will have the “Name” of the user that posted the message, the subject, the “date and time”, the “role” of the user that posted, the “location” of the user City and Country and the “time zone” of where the user is located. Topics and Messages can have associated icons to help users to identify the nature of the discussion more clearly.

2. Instant Project Messenger Management 49 Subprocess

Instant Project Messenger (FIG. 4-49) is an instant messaging system integrated into the VEMS system. A user needs a VEMS account to use the instant messaging system. It is a java application that is downloaded to a user at first use. The main features that differentiate it from other instant messaging systems are users visibility only in the community they belongs to.

3. To Do list Management 71 Subprocess

To Do List Management 71 provides an agenda or adviser implemented as a “to do” list. ToDo List is an easy-on-use daily activities information tool, having as a main duty tracking a user's daily ToDos list as well as keeping a diary and reminders of quick to do actions.

4. Notification Management 45 Subprocess

Virtual Enterprise Management System notifies the responsible persons of a task about event triggered by the system whenever they have to take care of a situation or they have to perform a specific action required. The specific action might be a document approval, or that a task is behind the schedule.

5. SMS Management 53 Subprocess

One of the communication channels Virtual Enterprise Management System might use to send notification is via mobile devices like mobile phones using the SMS feature via communication pathway 52 using the text messaging service available on digital mobile phones.

6. Palm 53 subprocess

This subprocess provides the interface to the Pocket PC devices, so that a virtual enterprise management system user may access system information using a Pocket PC (handheld) device.

D. Document and Work Flow Management 17 Process

Now referring to FIG. 5, the document and work flow management 17 process is shown. The document and work flow 17 process enables the creation of custom work flows for handling a multitude of process and document types such as proposals, statements of work, functional specifications; high level designs, images, and faxes. The document and workflow management process provide means to upload, add, edit, delete, mark read, mark unread, send to specific workflow, set access rights for documents of any format or folders; means to track document versions, display revision history page, means for the creation of custom workflows for handling a multitude of process and document types such as: proposals, statements of work, functional specifications, high level design, images, faxes and others. Users can define workflows unique to the organization or the project and set up multiple dispatchers for handling and distributing the information to various destinations by means that allow teams to share documents of most any type. Instead of sending attachments via email, a user can instantly upload a document to the VEMS System and have a team member at the airport or at a satellite office open and view or, if necessary, download the document.

A user can upload and download any file independent of the file type. To view a file within VEMS, A user must have a viewer application specific to the file type in question. These applications are available from most software manufacturers, but many common viewers are likely to be already installed in your browser. Common files include .doc, .xls, .jpg, .gif, and .pdf. A user may upload (post), delete, edit, rename, mark read/mark unread a document or create, share, delete, edit a folder structure. Only the user that posted the document and those with project manager roles have the right to edit, delete, rename a document. To edit the content of a document, a user must download it onto a local drive. Only those that posted the document and those with project manager roles have the ability to create, share, delete, edit a folder structure. When uploading a document, the user may choose document version control (FIGS. 5˜21). If the user uploads a document with version tracking when the document is downloaded on the local drive, the document is automatically checked out and the document status icon is changed to ‘check-out’. The document may be modified and then uploaded as a new version on the same folder in the document repository. When uploaded, the document is automatically ‘checked in’. In the mean time no one but the user that has ‘checked-out’ the document may upload a new version. Along with a robust Windows Explorer style Document Management tool with access rights and version control. The Documents and workflow management process 17 can show the tree structure of the documents visible in current communities for the current user. The document and workflow management process 17 allows a user to add/delete a folder, add/delete file, set access rights in access control subprocess 21, check in/check out a file.

1. Document Preview and Approval (DPA) 19 Management Subprocess

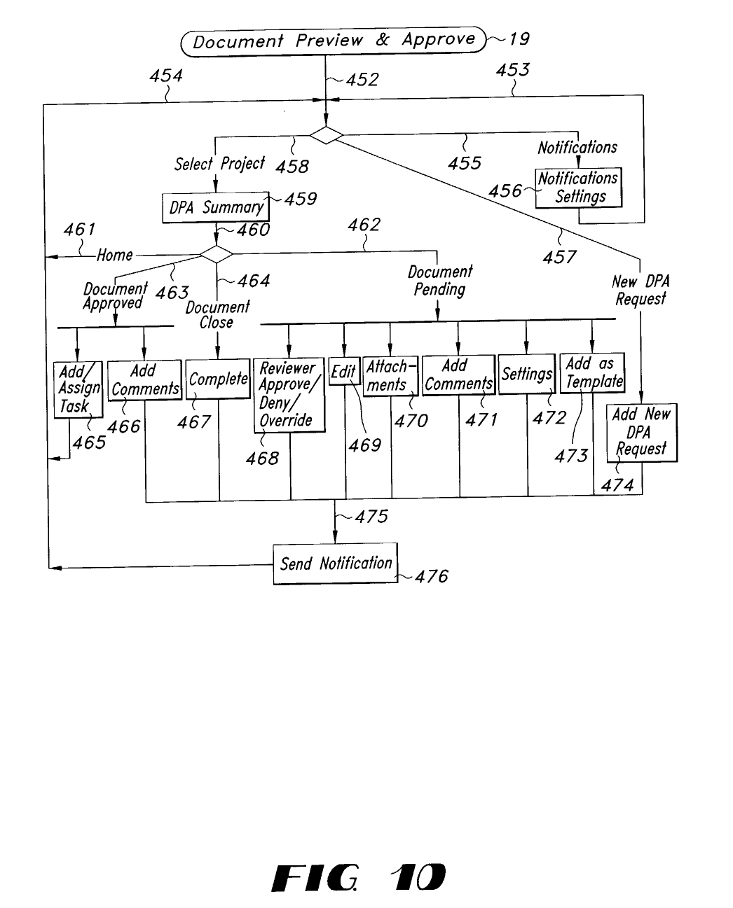

Document Preview and Approval 19 subprocess communicates via communication pathway 18 with document and workflow management 17 process. Document Preview and Approval (DPA) (FIG. 10) is an enhanced project management tool designed to give a user better control of project related documents, referring to their preview and approval. It allows a user to initiate and record all DPA requests, to assign responsibilities and to track the DPA through its lifecycle.

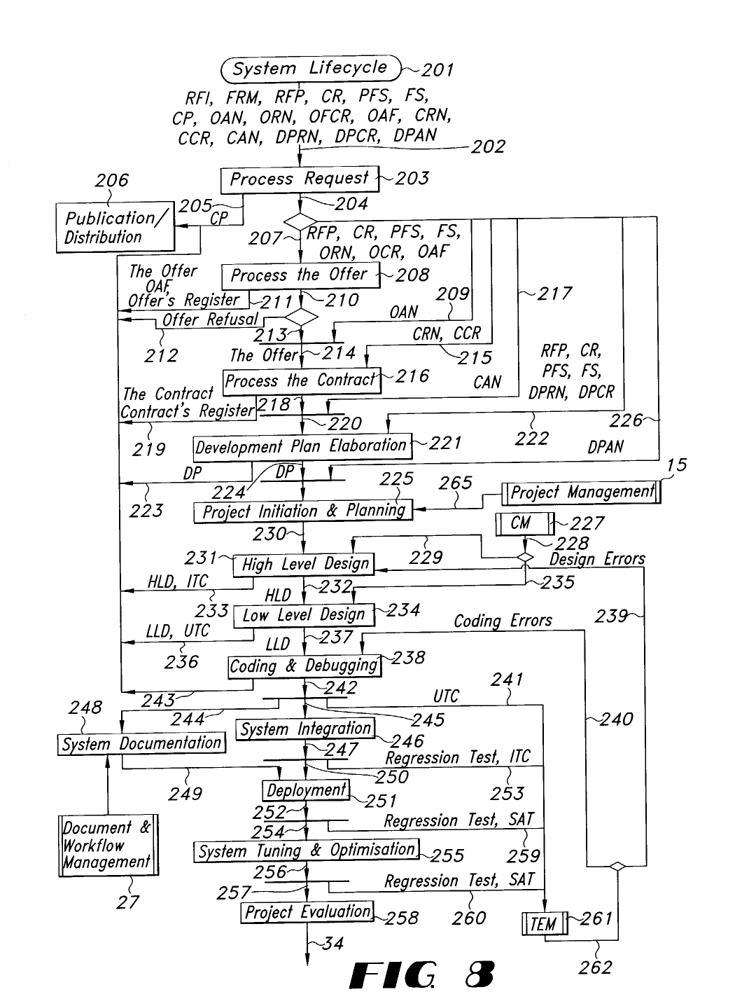

Project Lifecycle is the four sequential major time periods through which any project passes, namely: Concept; Definition (or Development); Execution (Implementation or Operation); and Finishing (Termination or Closeout). A project objective is to design and implement one or more systems. Initially the system lifecycle is initiated when an RFP comes from 301-306 via 316. The project is initiated in FIGS. 8-225. From this point on the project lifecycle covered by the project management 15 process manage the system lifecycle tasks and documents. Each period may be defined as a Phase and further broken down into stages that typically reflect the area of project management application and the size and complexity of the specific project. A collection of project phases whose name and number are determined by the control needs of the organization or organizations involved in the project. The complete set of time periods through which a project passes sequentially in a logical and orderly manner. In its simplest form the lifecycle involves four major periods: Concept (where the project concept as a 15 need solution is selected and defined); Development of Definition (where the concept is verified and developed into a workable plan for implementation); Implementation (where the implementation plan is carried out); and Closeout (where the project process is completed and documented, and the finished product is transferred to the care, custody and control of the owner). Progress through the project lifecycle is identified by milestones, but these major periods should be separated by Control Gates or Executive Control Points. The four sequential phases in time through which any project passes, namely: Concept; Definition (or Development); Execution (Implementation or Operation); Finishing (Termination or Closeout). These phases may be further broken down into stages depending on the area of project application. The period from project initiation to completion. The events, from beginning to end, necessary to complete a project. While there are many different versions of the project lifecycle, all contain the steps of germination of the idea, proposal and initiation, design and appraisal, mobilization of the team, execution and control, integration of the team and the sequence of phases through which the project will evolve. It is fundamental to the management of projects, and uniquely distinguishes projects from non-projects. It will significantly affect how the project is structured. All phases between a project's conception and its termination. The tool also allows you to see the impacts of the DPAs in time, cost and quality for any given project.

More specifically, with respect to FIG. 10, the document preview and approval subprocess 19 communicates via communication pathway 452, 455 with notification settings 456 (to set up the notifications time rates or other notifications parameters), with DPA summary 459 (to select the DPAs for a specific project) via 458 or add a new DPA request 474 via 457. If the document is approved 468 then a task can be added or assigned 465, comments can be added 466, via 463 and 460. A DPA can be closed 467 via 464 and 460. A pending document 462 can be reviewed 468, edited 469, receive attachments 470, add comments 471, change settings of a DPA (by which you can set up the different parameters of a DPA) 472, add as a template 473 via 462 and 460. The user may navigate to the DPA home page via 461 and 460.

2. Access Control 21 Management Subprocess

Access control 21 deals with the ability to enter the site of the project works and/or the necessary project data.

3. Version Control 23 Management Subprocess

Version control 23 deals with controlling the variants of some artifact; later versions of an artifact typically expand on earlier versions.

4. Document Repository 27 Management Subprocess

Document Repository 27 deals with documents, such as any official or authoritative paper containing instructions, information, evidence, facts and the life.

5. Workflow Management 25 Subprocess

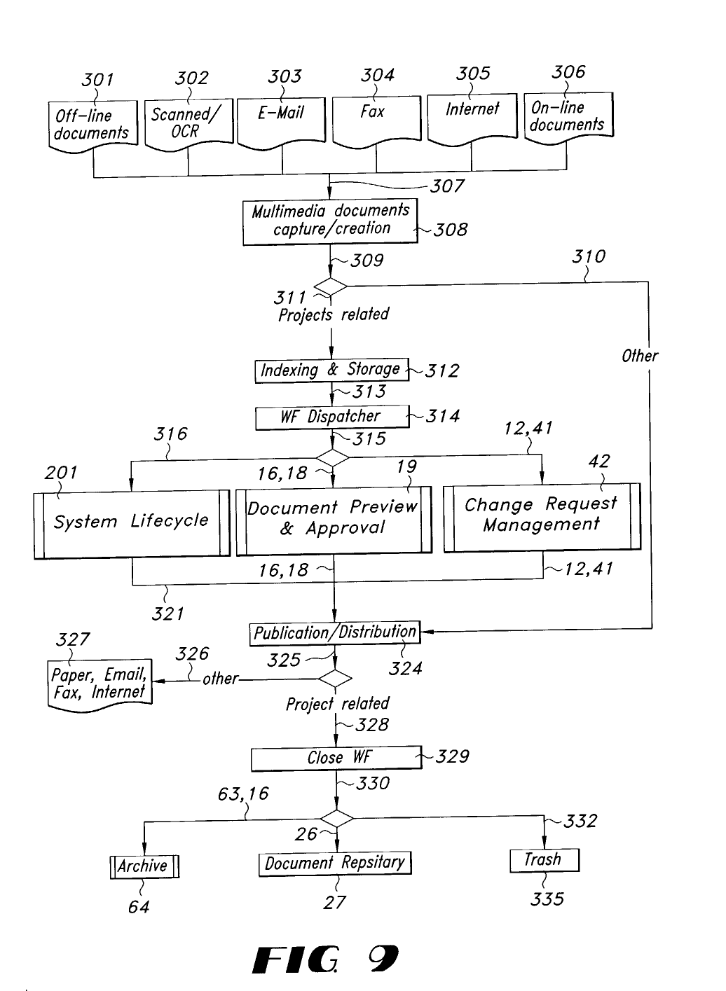

Workflow management 25 deals with the relationship of the activities in a project from start to finish. Workflow takes into consideration all types of activity relationships. In FIG. 9 a virtual enterprise management system document workflow is shown. The documents in different formats off-line 301, scanned/OCR 302, E-mail 303, Fax 304, Internet 305, On-line documents 306 are captured by multimedia documents capture/creation 308 via communication pathway 307. The project related documents are transmitted via communication pathway 309 and 311 and are indexed and stored in a database 312. The documents are transmitted via communication pathway 313 to the workflow dispatcher 314. The workflow dispatcher 314 sends the documents to the appropriate workflow pathways: system lifecycle 201, document preview and approval 319 subprocess or change request management 42 subprocess. The dispatcher, sends the document to the appropriate pathway (316 if it is a system lifecycle 201 workflow, 16, 18 if it is a document preview and approval 19 workflow, 12, 41 if it is a change request management 42 workflow) depending on the type of the document that comes as 301, 302, 303, 304, 305 or 306 and every organization internal procedures.

The processed documents are published and distributed by 324 via communication pathway 325 and 328 and closed 329 to an archive 334 via communication pathway 331 or send to trash 335 via communication pathway 335. All other documents that come via communication pathway 310 are published or distributed by paper, Email, Fax, Internet, 327 via communication pathway 326.

The three ways documents can be processed in the document and workflow management process 17 are by: system lifecycle workflow 201, document preview and approval 319 and change request management 42. More specifically with reference to FIG. 8, the system lifecycle workflow 201 is shown.

Now referring to FIG. 8, process request 203 goes to the system lifecycle workflow 201, via communication path 316, 202. A process request originates in 301, 302, 303, 304, 305 or 306 and follows the communication pathway 307 through 308, 309 to the dispatcher 314 up to the subprocess 201. The abbreviation shown in FIG. 8 is set out in Table 2.

TABLE 2

| Abbreviation | Description |
|---|---|
| RFI | Request for Information |
| RFM | Request for Marketing Materials |
| RFP | Request for Proposal |
| CR | Customer Requirements |
| PFS | Preliminary Functional Specifications |
| FS | Functional Specifications |
| CP | Company Presentation |
| OAN | Offer Acceptance Notification |
| ORN | Offer Refusal Notification |
| OFCR | OFfer Change Request |
| OAF | Offer Analysis Form |
| CRN | Contract Request Notification |
| CCR | Contract Change Request |
| CAN | Contract Acceptance Notification |
| DP | FS + PBS/WBS + TAC |
| DPRN | Development Plan Request Notification |
| DPCR | Development Plan Change Request |
| DPAN | Development Plan Acceptance Notification |
| PBS/WBS | Project Breakdown Structure/Work Breakdown Structure |
| SAT | System Acceptance Test Cases |
| RA | Risk Assessment |
| RMP | Risk Management Plan |
| CM | Change Management |
| TEM | Test & Error Management |
| HLD | High Level Design |
| LLD | Low Level Design |
| UTC | Unit Test Cases |
| ITS | Integration Test Cases |
| DCWM | Document-Centric Workflow Management |

A process request 203 follows the communication pathway 207 and the process the offer 208 is started. The project related documents like offer is initiated in 208. The offer request might be refused ORN via 211 or approved OAN by the client via communication pathway 209.

The offer follows the communication pathway 213, 214 and the process the contract is started 216. The contract approval CAN comes via communication pathway 215, 220. The development plan elaboration 221 is started next and then the project initiation and planning 225 by project management process 15 via communication pathway 265. The system workflow continues with the high level design 231, low level design 234, coding and debugging 238, system integration 247, deployment 251, system tuning and optimization 255, project evaluation 258, via communication pathways 230, 232, 237, 242, 245, 247, 252, 254, 356, 257.

The project change requests are managed by change management 42 via communication pathway 42. The system documentation 248 is managed by document and workflow management process 17 via communication pathway 266.

6. Document Management 76 Subprocess

The document management subprocess 76 communication via communication pathway 75 with document and workflow management 17 process. Document management 76 subprocess facilitates the deletion of a folder 805, the addition of a folder 806, the addition or deletion of a file 807 and the process of checking a file (or folder) in or out by the user 809. The user can also add new document versions via version control subprocess 23.

E. Quality Assurance Management 72 Process

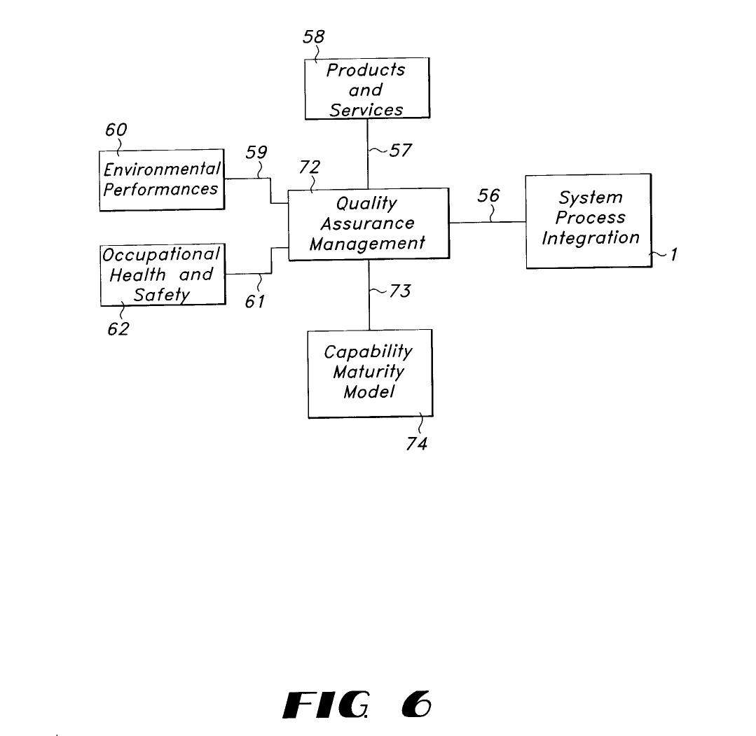

Now referring to FIG. 6, the quality assurance management 72 process is shown in a block diagram. The quality assurance management 72 process communicates via communication pathway 57 with products and services 58 subprocess. The quality assurance management process 72 communicates via communication pathway 59 with environmental performances 60 subprocess. The quality assurance management process 72 communicates via communication pathway 61 with occupational health and safety process 62. The quality assurance management process 72 communicates via communication pathway 73 with CMM (Capability Maturity Model) 74 subprocess. The quality assurance management 72 process maintain the quality system documents by means of document workflow management process 17 via communication pathways 56,16 through system process integration 1. The quality assurance management process 72 provides means for management of quality services; means to integrate the standards and documents of the global recognized quality standards of ISO 9000 (Products and Services), ISO 14000 (Environment), ISO 18000 (OHSMS Employee) and CMM (Software Development); means to provide document templates to use and customize for implementing a quality system; and means to become ISO or CMM certified, or to maintain an existing certification.

Standards are constantly changing, but one thing that is constantly needed is a quality assurance management system. VEMS integrates the standards and documents of the global recognized quality standards of ISO 9000 (Products & Services), ISO 14000 (Environment), ISO 18000 (OHSMS Employee) and CMM (Software Development). VEMS 's extensive CMM reports cover: Progress, Effort, Cost, Quality, Stability, Computer Resource Utilization and Training. These subprocesses represent a means to distribute and maintain the quality system documentation.

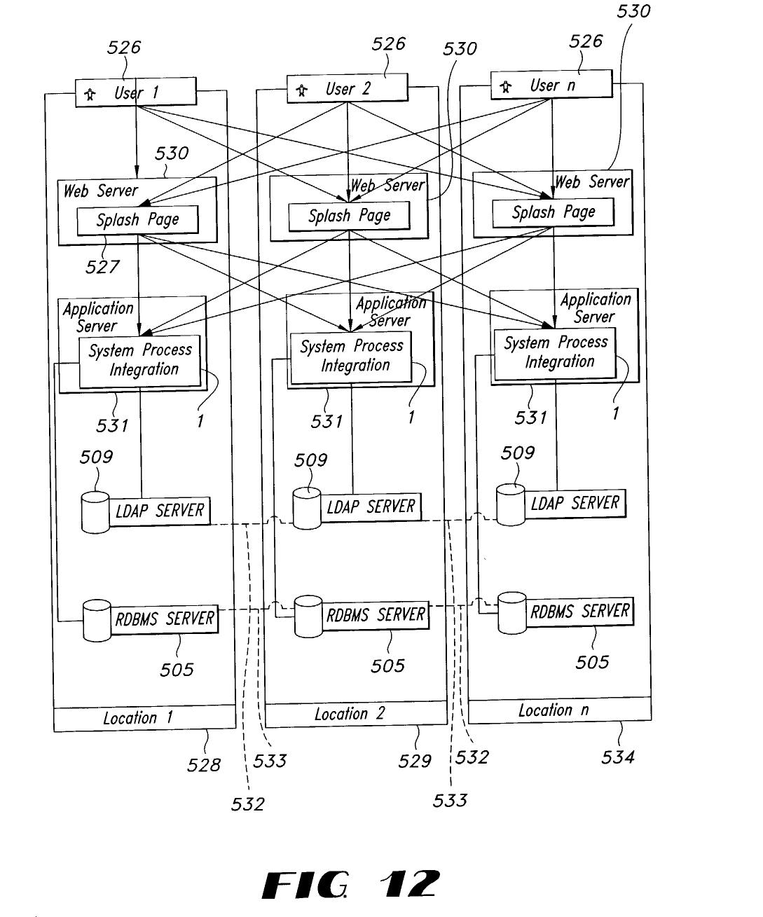

Now referring to FIG. 12, the minimal deployment configuration of the system involves four servers: a web server 530 where the splash page 527 can be accessed by the user 526 through a web server 530, an application server 531 where the system process integration 1 is the main process running, a relational database server 505 and an LDAP server 509, on one deployment location 528, or at other deployment locations 529 or 534. The splash page 527 is the first HTML page the virtual management system user accesses when a user types in the URL. The splash page 527 chooses the nearest virtual enterprise system deployment location relative to the user location on the Internet. The servers can all be deployed on one machine or on different machines depending on the organization size. The deployment platform, for example is a Sun SPARC® machine with two processors or an Intel Machine, Dell PowerEdge® 2400 for the web server and the application server, and a Windows NT® for the RDBMS server and LDAP server. In case of a large organization, the present method and system involves very low access time, mainly because of the connection speed that might be very low. For this reason, the present method and system can be deployed on a distributed environment.

A distributed computing environment is at more than one geographic location. All the four servers are deployed on each location. The LDAP 509 and relational databases 505 are replicated so that data consistency is preserved. Any database updated information on one location is replicated instantly to other locations by means of the relational database and LDAP database replication mechanisms. Each location has a splash page 527 on the web server 530 where the user 526 request is redirected to the nearest location. This way the user 526 needs only to know a single URL and he will be automatically redirected to the nearest site. This is possible because the application is web enabled—that means the user (526) needs only a web browser to access the present system.

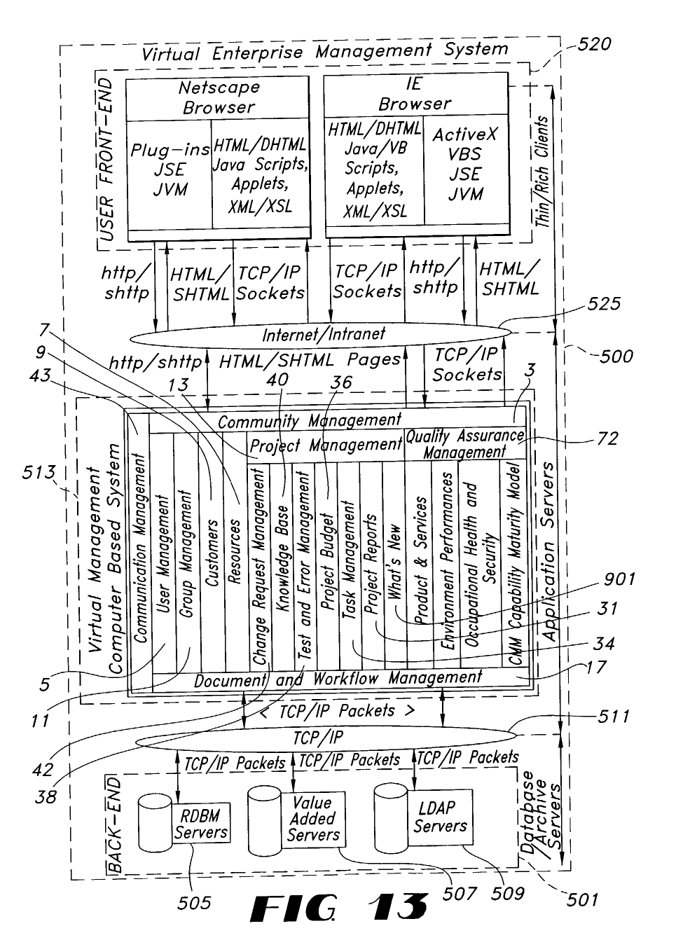

Now referring to FIG. 13, the multi tier architecture of the virtual enterprise management system 500 is shown. More specifically, this invention provides a program storage device readable by a machine tangible embodying a program of instruction such as computer readable program codes which are incorporated by reference as the computer program listing appendix. The programs of instruction are executable by a machine, such as a computer, to perform certain method steps for facilitating the management of a virtual enterprise via the web. The method steps include facilitating: the management of communities, the management of activities organized into projects, management of documents, communication, facility assurance and the integration of these management processes via system process integration 1.

Block 501 shows the back end of the virtual enterprise management system 500. The back end 501 is made of database 503, Runs database servers 505, value added servers 507 (such as other Enterprise Resource Planning or legacy applications servers) and light weight direct access protocol server LDAP 509. This group is referred to collectively as database/archive servers. The backend 501 communicated with the application servers 531 via TCP/IP protocol. The application servers 531 include the virtual management computer based system 513 including the processes and subprocesses of community management 3, communication management 43, project management 13, document and workflow management 17, and quality management 72.

The user front end box 520 is made of various browsers, such as Netscape (Mountain View, Calif.). A thin or rich client is anticipated as the predesignated user. The user communicates using various known protocol with the Internet/Intranet 525 and, in turn, communicates with the virtual management computer based system.

Although the present invention has been described and illustrated with respect to preferred embodiments and preferred uses thereof, it is not so limited since modifications and changes can be made therein which are within the full scope of the invention. The invention is therefore not limited to specific preferred embodiments as described, but is only limited as defined by the following claims.

We claim:

1. A computer program product, said computer program product comprising:
a computer usable medium having computer readable program code means therein facilitating the web based management of a virtual enterprise; the computer readable program codes means in said computer program product comprising:
computer readable program code means for facilitating the web based management of a virtual enterprise by system process integration of defined management processes.

2. The product of claim 1 wherein said defined management process is community management.

3. The product of claim 1 wherein said defined management process is communication management.

4. The product of claim 1 wherein said management process is project management.

5. The product of claim 1 wherein said defined management process is document and workflow management.

6. The product of claim 1 wherein said defined management process is quality assurance.

7. The product of claim 2 wherein the community management proces communicates with user management subprocess.

8. The product of claim 2 wherein the community management process communicates with resources subprocess.

9. The product of claim 2 wherein the community management process communicates with customers subprocess.

10. The product of claim 2 wherein the community management process communites with group management subprocess.

11. The product of claim 4 wherein the project management process comunicates with the projects listing management subprocess.

12. The product of claim 4 wherein the project management process communicates with change request management subprocess.

13. The product of claim 4 wherein the project management process communicates with knowledge base management subprocess.

14. The product of claim 4 wherein the project management process communicates with test and error management subprocess.

15. The product of claim 4 wherein the project management process communicates with project budget management subprocess.

16. The product of claim 4 wherein the project management process communicates with task management subprocess.

17. The product of claim 4 wherein the project management process communicates with project reports management subprocess.

18. The product of claim 4 wherein the project management process communicates with what's new management subprocess.

19. The product of claim 4 wherein the project management process communicates with time reports management subprocess.

20. The product of claim 3 wherein the communication management process communicates with discussions management subprocess.

21. The product of claim 3 wherein the communication management process communicates with instant project messenger management subprocess.

22. The product of claim 3 wherein the communication management process communicates with to do list management subprocess.

23. The product of claim 3 wherein the communication management process communicates with notification management subprocess.

24. The product of claim 3 wherein the communication management process communicates with SMS subprocess.

25. The product of claim 3 wherein the communication management process communicates with e-mail subprocess.

26. The product of claim 3 wherein the communication management process communicates with palm subprocess.

27. The product of claim 5 wherein document and workflow management process communicates with access control management subprocess.

28. The product of claim 5 wherein document and workflow management process communicates with version control management subprocess.

29. The product of claim 5 wherein document and workflow management process communicates with document repository subprocess.

30. The product of claim 5 wherein the document and workflow management process communicates with document preview and approval subprocess

31. The product of claim 5 wherein the document and workflow management process communicates with document management subprocess.

32. The product of claim 5 wherein the document and workflow management process communicates with workflow management subprocess.

33. The product of claim 32 wherein the document and workflow management subprocess includes program code facilitating system lifecycle workflow

34. The product of claim 6 wherein said quality assurance management subprocess communicates with products and services subprocess.

35. The product of claim 6 wherein said quality assurance management subprocess communicates with environmental performances subprocess.

36. The product of claim 6 wherein said quality assurance management subprocess communicates with occupation health and safety subprocess.

37. The product of claim 6 wherein said quality assurance management subprocess communicates with capability maturity model subprocess.

38. The product of claim 4 wherein the project management process includes program codes facilitating estimation of project completion date.

39. A program storage device readable by a machine tangibly embodying a program of instructions executable by the machine to perform method steps for facilitating the management of a virtual enterprise by users via the web, said method steps comprising:
(a) facilitating the management of users organized in communities;
(b) facilitating the management of activities organized in projects;
(c) facilitating the management of documents;
(d) facilitating the management of communications;
(e) facilitating the management of quality assurance; and
(f) integrating steps (a) through (e).

40. The method of claim 39 wherein a community administrator defines the communities.

41. The method of claim 39 wherein documents are processed by system lifecycle workflow.

42. The method of claim 39 wherein documents are processed by document preview and approval workflow.

43. The method of claim 39 wherein documents are processed by change management workflow.

44. The method of claim 39 wherein facilitating the management of activities organized into projects involves the step of estimating the project completion date.

45. A system for allowing pre-designated users at remotely located computer-based systems to perform management of a virtual enterprise comprising:
a data network;
a remote storage facility; and
at least four servers to deploy the computer program of claim 1.

46. The system of claim 45 wherein said data network is private.

47. The system of claim 45 wherein said data network is public.
